(19) United States
(12) Patent Application Publication
(10) Pub. No.: US 2020/0395777 A1
(43) Pub. Date: Dec. 17, 2020

(54) CONTROL APPARATUS, CONTROL METHOD, AND PROGRAM

(71) Applicant: HONDA MOTOR CO., LTD., Tokyo (JP)

(72) Inventor: Shigeru Namiki, Wako-shi (JP)

(21) Appl. No.: 16/898,611

(22) Filed: Jun. 11, 2020

(30) Foreign Application Priority Data
Jun. 13, 2019 (JP) 2019-110599

(51) Int. Cl. H02J 7/00; B60L 58/12

(52) U.S. Cl. CPC H02J 7/0063; B60L 58/12; H02J 7/0048; H02J 7/007

(57) ABSTRACT

A control apparatus includes: an acquisition part that acquires a state of a battery that is mounted on an electric vehicle; and a control part that performs an output control of the battery, wherein the control part controls an output of a battery attached to an electric vehicle with reference to one output limitation pattern set from a plurality of output limitation patterns each having a different output level and changes the output limitation pattern from an initial output limitation pattern to an output limitation pattern having a high output level based on the acquired state of the battery.

### CROSS-REFERENCE TO RELATED APPLICATION

Priority is claimed on Japanese Patent Application No. 2019-110599, filed on Jun. 13, 2019, the contents of which are incorporated herein by reference.

### BACKGROUND

### Field of the Invention

The present invention relates to a control apparatus, a control method, and a program.

### Background

A battery (secondary battery) such as a lithium-ion battery is used for an electric vehicle such as an electric automobile or a hybrid vehicle. In order to stably supply the battery in the future, it is conceivable that actively utilizing a secondary use is effective. In the related art, techniques regarding devices and methods for providing energy management and maintenance of a battery that is secondarily utilized through the use of a secondary service port have been disclosed (for example, refer to Japanese Unexamined Patent Application, First Publication No. 2013-243913).

### SUMMARY

In the related art, the output control of a battery that is secondarily utilized has not been sufficiently considered.

An aspect of the present invention is to provide a control apparatus, a control method, and a program capable of appropriately controlling an output of a battery that is secondarily utilized.

A control apparatus according to a first aspect of the present invention includes: an acquisition part that acquires a state of a battery that is mounted on an electric vehicle; and a control part that performs an output control of the battery, wherein the control part controls an output of a battery attached to an electric vehicle with reference to one output limitation pattern set from a plurality of output limitation patterns each having a different output level and changes the output limitation pattern from an initial output limitation pattern to an output limitation pattern having a high output level based on the acquired state of the battery.

A second aspect of the present invention is the control apparatus according to the first aspect described above, wherein the control part may change the output limitation pattern such that the output level of the output limitation pattern referred by the control part is increased in a step-by-step manner based on the acquired state of the battery.

A third aspect of the present invention is the control apparatus according to the first or second aspect described above, wherein the control part may limit the output of the battery with reference to an output limitation pattern having the lowest output level among the plurality of output limitation patterns in a case where a battery different from the battery that has been attached to the electric vehicle is attached to the electric vehicle.

A fourth aspect of the present invention is the control apparatus according to the first to third aspects described above, wherein the control part may limit the output of the battery with reference to an output limitation pattern having the lowest output level among the plurality of output limitation patterns in a case where a used battery is attached to the electric vehicle.

A fifth aspect of the present invention is the control apparatus according to the first to fourth aspects described above, wherein the control part may acquire the state of the battery based on a detection value of a battery sensor attached to the battery using a capacitance of the battery, a SOC-OCV curve of the battery, and a three-dimensional space model of an internal resistance of the battery.

A sixth aspect of the present invention is a control method, by way of a computer, including: acquiring a state of a battery that is mounted on an electric vehicle; controlling an output of a battery attached to an electric vehicle with reference to one output limitation pattern set from a plurality of output limitation patterns each having a different output level; and changing the output limitation pattern from an initial output limitation pattern to an output limitation pattern having a high output level based on the acquired state of the battery.

A seventh aspect of the present invention is a computer-readable non-transitory storage medium that includes a program causing a computer to: acquire a state of a battery that is mounted on an electric vehicle; control an output of a battery attached to an electric vehicle with reference to one output limitation pattern set from a plurality of output limitation patterns each having a different output level; and change the output limitation pattern from an initial output limitation pattern to an output limitation pattern having a high output level based on the acquired state of the battery.

According to the first to seventh aspects described above, it is possible to appropriately control an output of a battery that is secondarily utilized.

### BRIEF DESCRIPTION OF THE DRAWINGS

FIG. 1 is a view showing an example of a configuration of a vehicle on which a control apparatus according to the present invention is mounted.

FIG. 2 is a configuration view of a battery device according to a first embodiment of the present invention.

FIG. 3 is a configuration view of a battery and VCU control unit according to an embodiment of the present invention.

FIG. 4 is a view showing an example of three-dimensional space model information.

FIG. 5 is a view showing an example of an output limitation pattern.

FIG. 6 is a reference view showing an example of an output limitation (1).

FIG. 7 is a reference view showing an example of an output limitation (2).

FIG. 8 is a reference view showing an example of an output limitation (3).

FIG. 9 is a flowchart showing an example of a process flow by a control part.

FIG. 10 is a flowchart showing an example of a process flow by the control part.

### DESCRIPTION OF EMBODIMENTS

### First Embodiment

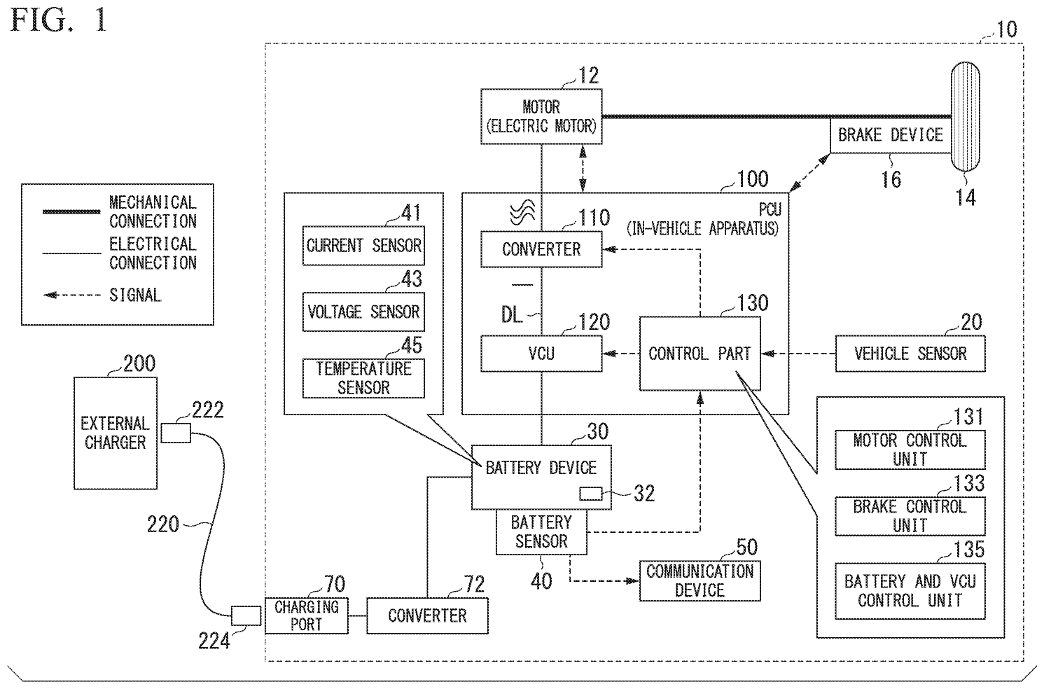

Hereinafter, a control apparatus, a control method, and a program according to an embodiment of the present invention will be described with reference to the drawings. FIG. 1 is a view showing an example of a configuration of a vehicle 10 on which a control apparatus according to the present invention is mounted. As shown in FIG. 1, the vehicle 10 includes, for example, a motor 12, a drive wheel 14, a brake device 16, a vehicle sensor 20, a battery device 30, a battery sensor 40, a communication device 50, a charging port 70, a converter 72, and a PCU (Power Control Unit) 100. The PCU 100 is an example of the control apparatus.

The motor 12 is, for example, a three-phase alternate current motor. A rotor of the motor 12 is connected to the drive wheel 14. The motor 12 outputs power to the drive wheel 14 using supplied electric power. The motor 12 generates electric power using a kinetic energy of a vehicle at the time of deceleration of the vehicle.

The brake device 16 includes, for example, a brake caliper, a cylinder that transmits a hydraulic pressure to the brake caliper, and an electric motor that generates hydraulic pressure in the cylinder. The brake device 16 may include, as a backup, a mechanism that transmits the hydraulic pressure generated by an operation of a brake pedal to the cylinder via a master cylinder. The brake device 16 is not limited to the configuration described above, and may be an electronically controlled hydraulic brake device that transmits the hydraulic pressure of the master cylinder to the cylinder.

The vehicle sensor 20 includes, for example, an accelerator opening degree sensor, a vehicle speed sensor, and a brake depression amount sensor. The accelerator opening degree sensor is attached to an accelerator pedal which is an example of an operation element that accepts an acceleration command by a driver, detects an operation amount of an accelerator pedal, and outputs, as an accelerator opening degree, the detected operation amount of the accelerator pedal to the PCU 100. The vehicle speed sensor includes, for example, a wheel speed sensor attached to each wheel and a speed calculator, derives a speed (vehicle speed) of a vehicle by combining wheel speeds detected by the wheel speed sensor, and outputs the derived vehicle speed to the PCU 100. The brake depression amount sensor is attached to the brake pedal, detects an operation amount of the brake pedal, and outputs, as a brake depression amount, the detected operation amount of the brake pedal to the PCU 100.

The PCU 100 includes, for example, a converter 110, a VCU (Voltage Control Unit) 120, and a control part 130. The converter 110 is, for example, an AC-DC converter. A DC side terminal of the converter 110 is connected to a direct current link DL. The battery device 30 is connected to the direct current link DL via the VCU 120. The converter 110 converts an alternate current generated by the motor 12 into a direct current, and outputs the converted direct current to the direct current link DL. The VCU 120 is, for example, a DC-DC converter. The VCU 120 increases the voltage of electric power supplied from the battery device 30 and outputs the electric power having the increased voltage to the direct current link DL.

The control part 130 includes, for example, a motor control unit 131, a brake control unit 133, and a battery and VCU control unit 135. The motor control unit 131, the brake control unit 133, and the battery and VCU control unit 135 may be replaced by separate control devices that are, for example, control devices such as a motor ECU, a brake ECU, and a battery ECU. The control part 130 controls the operation of each portion of the vehicle 10 such as the converter 110, the VCU 120, and the battery device 30.

The control part 130 is realized, for example, by a hardware processor such as a CPU (Central Processing Unit) executing a program (software). Some or all of these constituent elements may be realized by hardware (a circuit part including circuitry) such as a LSI (Large Scale Integration), an ASIC (Application Specific Integrated Circuit), a FPGA (Field-Programmable Gate Array), and a GPU (Graphics Processing Unit) or may be realized by cooperation of software and hardware.

The program may be stored in a storage device (non-transitory storage medium) such as a HDD (Hard Disk Drive) or a flash memory in advance or may be stored in a detachable storage medium (non-transitory storage medium) such as a DVD or a CD-ROM and installed by the storage medium being attached to a drive device.

The motor control unit 131 controls the motor 12 on the basis of an output of the vehicle sensor 20. The brake control unit 133 controls the brake device 16 on the basis of the output of the vehicle sensor 20.

The battery and VCU control unit 135 controls an output of the battery device 30. For example, the battery and VCU control unit 135 calculates a SOC (State Of Charge) of the battery 32 on the basis of an output of the battery sensor 40 attached to a battery 32 (described later) of the battery device 30 and outputs the calculated SOC to the VCU 120. The VCU 120 increases a voltage of the direct current link DL in response to a command from the battery and VCU control unit 135. Details of the battery device 30 will be described later.

The battery sensor 40 includes, for example, a current sensor 41, a voltage sensor 43, a temperature sensor 45, and the like. The battery sensor 40 detects, for example, a current value and a voltage value at the time of charging or discharging, a temperature, and the like of the battery 32. The battery sensor 40 outputs the detected current value, the detected voltage value, the detected temperature, and the like to the control part 130 and the communication device 50. The battery sensor 40 may be housed within a housing of the battery device 30 or may be attached to an outside of the housing. Hereinafter, the current value, the voltage value, the temperature, and the like detected by the battery sensor 40 are referred to as a battery parameter.

The communication device 50 includes a wireless module for connecting a wireless communication network such as a wireless LAN or a cellular network. The wireless LAN may be, for example, in a form such as the Wi-Fi (registered trademark), Bluetooth (registered trademark), or Zigbee (registered trademark). The cellular network may be, for example, a third-generation mobile communication network (3G), a fourth-generation mobile communication network (Long Term Evolution: LTE (registered trademark)), a fifth-generation mobile communication network (5G), or the like. The communication device 50 may acquire a current value, a voltage value, a temperature, and the like output from the battery sensor 40 and may transmit the current value, the voltage value, the temperature, and the like to the outside.

The charging port 70 is provided to be directed toward the outside of a vehicle body of the vehicle 10. The charging port 70 is connected to an external charger 200 via a charging cable 220. The charging cable 220 includes a first plug 222 and a second plug 224. The first plug 222 is connected to the external charger 200, and the second plug 224 is connected to the charging port 70. Electricity supplied from the external charger 200 is supplied to the charging port 70 via the charging cable 220.

The charging cable 220 includes a signal cable attached to an electric power cable. The signal cable mediates communications between the vehicle 10 and the external charger 200. Accordingly, an electric power connector and a signal connector are provided on each of the first plug 222 and second plug 224.

The converter 72 is provided between the battery device 30 and the charging port 70. The converter 72 converts a current introduced from the external charger 200 via the charging port 70, that is, for example, an alternate current into a direct current. The converter 72 outputs the converted direct current to the battery device 30.

FIG. 2 is a configuration view of the battery device 30 according to a first embodiment of the present invention. The battery device 30 of the present embodiment includes, for example, an electric power input and output terminal 31, a battery (electric power storage part) 32, a signal input and output part 33, a switch part 34, and a storage part 35. These constituent elements are housed in one housing.

The battery device 30 is connected to an electric power system of the vehicle 10 via the electric power input and output terminal 31.

The battery 32 stores electric power supplied from the external charger 200 and performs discharging for traveling of the vehicle 10. The battery 32 is, for example, a lithium-ion battery, an all solid-state battery, or the like. The battery 32 may be an assembled battery in which battery cells are integrated.

The signal input and output part 33 is connected to the control part 130 of the vehicle 10. The signal input and output part 33 includes, for example, a signal terminal (connector) to which a plug or the like is connected. A security signal is input to the signal input and output part 33. The signal input and output part 33 is connected to the storage part 35 via the switch part 34.

The storage part 35 may be a storage device (non-transitory storage medium) such as a HDD (Hard Disk Drive) or a flash memory or may further include a control circuit that enables or disables writing of information to the storage device or readout of information from the storage device in addition to the storage device such as the HDD or the flash memory. For example, an electric power capacity value of the battery 32, an internal resistance value of the battery 32, information regarding a SOC-OCV curve characteristic of the battery 32, and the like are stored in the storage part 35. These information are written by the control part 130 or read out by the control part 130.

Here, a writing operation of information to the storage part 35 by the control part 130 is described. The control part 130 generates charging information of the battery device 30 on the basis of the current value, the voltage value, the temperature, and the like detected by the battery sensor 40 and writes the charging information to the storage part 35. The charging information includes, for example, an internal resistance value, a SOC (State Of Charge)-OCV (Open Circuit Voltage) curve characteristic, an ambient temperature of the battery device 30, a capacitance at the time of full charge, and the like. Here, the full charge refers to a state in which the capacity of the electric power storage part is maximally charged at a predetermined time. The control part 130 may perform generating of the charging information of the battery device 30 and writing of the charging information to the storage part 35 every predetermined time, that is, for example, every minute, every hour, or every day, or on the basis of a command of a user of the vehicle 10.

The switch part 34 includes, for example, a control circuit such as an IC (Integrated Circuit) that interprets the contents of the security signal input to the signal input and output part 33. The switch part 34 switches readout of the information stored in storage part 35 from the outside to be enabled or disabled. The switch part 34 is continuously operating by receiving supply of weak electric power from the battery 32.

The switch part 34, for example, enables readout of the information stored in the storage part 35 from the outside in a case where the security signal input to the signal input and output part 33 is an enable signal (release signal). Thereby, unless the signal input and output part 33 receives the security signal including the enable signal (release signal), the switch part 34 does not enable readout of the information stored in the storage part 35 from the outside. Therefore, when the battery device 30 is removed from the vehicle 10 and is secondarily utilized, only in a case where an appropriate use of the battery device 30 is assured to some extent, it is possible to provide information required for utilizing the battery device 30.

The security signal received by the signal input and output part 33 may include a disabling signal (invalidation signal). The disabling signal (invalidation signal) is a signal for switching readout of information stored in the storage part 35 from the outside to be disabled. The switch part 34 may enable or disable writing of information in conjunction with enabling or disabling of readout of information.

The switch part 34 includes an internal memory that stores predetermined identification information. When the identification information included in the security signal matches the identification information stored by the internal memory, the switch part 34 may perform a control of readout (or writing) of the information from the storage part 35. When the identification information included in the security signal does not match the identification information stored by the internal memory, the switch part 34 may not perform the control of readout or writing of the information from the storage part 35. The “matching” may include partial matching of the contents, the possibility of decoding of encrypted information by combining both contents, and the like in addition to complete matching of the contents. Hereinafter, it is assumed that the switch part 34 requires matching of the identification information.

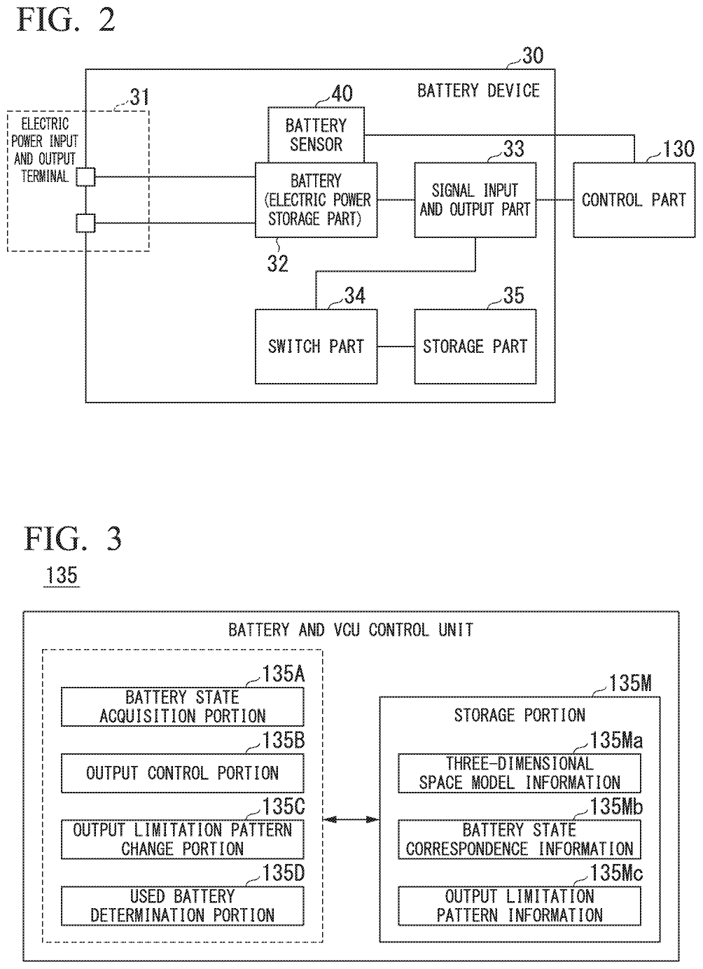

FIG. 3 is a configuration view of the battery and VCU control unit 135 according to the embodiment of the present invention. The battery and VCU control unit 135 of the present embodiment includes, for example, a battery state acquisition portion 135A, an output control portion 135B, an output limitation pattern change portion 135C, a used battery determination portion 135D, and a storage portion 135M. For example, three-dimensional space model information 135Ma, battery state correspondence information 135Mb, and output limitation pattern information 135Mc are stored in the storage portion 135M.

The battery state acquisition portion 135A, the output control portion 135B, the output limitation pattern change portion 135C, and the used battery determination portion 135D are realized, for example, by a processor such as a CPU executing a program (software) stored in the storage portion 135M. Some or all of the functional portions included in the battery and VCU control unit 135 may be realized by hardware (a circuit part including circuitry) such as a LSI, an ASIC, a FPGA, and a GPU or may be realized by cooperation of software and hardware. The program may be stored in a storage device (non-transitory storage medium) such as a HDD or a flash memory in advance or may be stored in a detachable storage medium (non-transitory storage medium) such as a DVD or a CD-ROM and installed by the storage medium being attached to a drive device. The storage portion 135M is realized by the storage device described above.

The battery state acquisition portion 135A, for example, reads charging information from the storage part 35 of the battery device 30 and acquires a battery state of the battery 32 on the basis of the read charging information. The battery state is information indicating a degree of degradation that progresses in accordance with a usage situation of the battery 32 and is represented, for example, by a state level indicating the degree of degradation using a numerical value. The state level includes, for example, a state level R1, a state level R2, a state level R3 . . . in the order from a low degradation degree of the battery 32 to a high degradation degree of the battery 32.

For example, the battery state acquisition portion 135A reads, as the charging information, the electric power capacity value of the battery 32, the internal resistance of the battery 32, and the SOC-OCV curve characteristic of the battery 32 from the storage part 35. The battery state acquisition portion 135A refers to the three-dimensional space model information 135Ma stored in the storage portion 135M and acquires a coordinate of a three-dimensional space model indicated by the read charge information. The coordinate of the three-dimensional space model is, for example, preliminarily associated with the state level of the battery 32 in the battery state correspondence information 135Mb stored in the storage portion 135M. The battery state acquisition portion 135A refers to the battery state correspondence information 135Mb stored in the storage portion 135M and acquires the state level of the battery 32 on the basis of the derived coordinate.

The battery state acquisition portion 135A may derive the charging information including the electric power capacity value of the battery 32, the internal resistance of the battery 32, and the SOC-OCV curve characteristic of the battery 32 on the basis of the detection result of the battery parameter (for example, the current value, the voltage value, the temperature, and the like) acquired from the battery sensor 40 and then acquire the battery state on the basis of the derived charging information.

The battery state acquisition portion 135A may acquire the battery state on the basis of a transition (change) of the battery state defined by the three-dimensional space model. For example, the battery state acquisition portion 135A may acquire the battery state on the basis of a transition from a coordinate of the three-dimensional space model based on the charging information read from the storage part 35 of the battery device 30 to a coordinate of the three-dimensional space model based on the detection result of the battery parameter. The battery state acquisition portion 135A may acquire the battery state on the basis of a transition between coordinates of the three-dimensional space model based on the charging information read from the storage part 35 of the battery device 30. The battery state acquisition portion 135A may acquire the battery state on the basis of a transition between coordinates of the three-dimensional space model based on the detection result of the battery parameter.

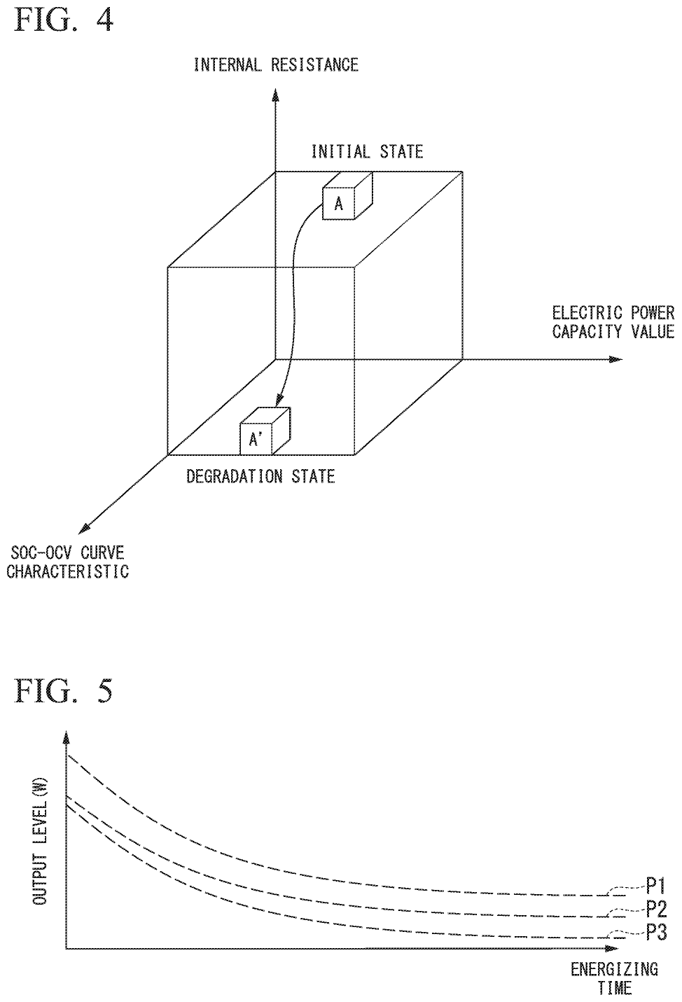

The three-dimensional space model information 135Ma is information for determining the battery state using the three-dimensional space model. The three-dimensional space model information 135Ma is, for example, a space model defined in a three dimension of the electric power capacity value of the battery, the internal resistance of the battery, and the SOC-OCV curve characteristic of the battery. FIG. 4 is a view showing an example of the three-dimensional space model information 135Ma.

In the three-dimensional space model information 135Ma, a transition curve is defined in which the battery state transitions from an initial state A toward a degradation state A′. The transition curve is determined in advance for each type of battery or for each product.

The battery state correspondence information 135Mb is, for example, information in which the coordinate of the three-dimensional space model information 135Ma is associated with the state level of the battery. For example, the state level of the battery is associated with a set of coordinates within a certain range of the periphery including the transition curve shown in FIG. 4.

The output limitation pattern information 135Mc includes, for example, a plurality of output limitation patterns each having a different output level. The output limitation pattern is a set of upper limit values of the output level predetermined depending on an energizing time. The output level is, for example, an output electric power (W) of the battery 32 but is not limited thereto. The output level may be an electric energy (Wh) used for the vehicle 10 to travel.

FIG. 5 is a view showing an example of the output limitation pattern. As shown in the drawing, each output limitation pattern is a function where the horizontal axis is represented by an energizing time, and the vertical axis is represented by an output level. The output limitation pattern information 135Mc includes, for example, a plurality of output limitation patterns P1 to P3. The output limitation pattern P1 has the highest output level at the same energizing time among the output limitation patterns P1 to P3. The output limitation pattern P3 has the lowest output level at the same energizing time among the output limitation patterns P1 to P3.

The output control portion 135B is a control part that performs an output control of the battery 32. The output control portion 135B sets an output limitation pattern having the lowest output level when a different battery 32 is attached. The output control portion 135B controls the output of the battery 32 with reference to set output limitation pattern. For example, the output control portion 135B refers to the set output limitation pattern and limits the output of the battery 32 such that the output of the battery 32 becomes an output level corresponding to the energizing time at a control time point.

The output control portion 135B writes, to the storage portion 135M, information in which identification information (hereinafter, referred to as an output limitation pattern ID) indicating the set output limitation pattern is associated with identification information (hereinafter, referred to as a battery ID) indicating the battery 32. For example, the output control portion 135B refers to the battery ID stored in the storage portion 135M and determines that a different battery 32 is attached when the battery ID stored in the storage portion 135M does not match the battery ID read from the storage part 35 of the battery device 30.

The output limitation pattern change portion 135C changes the output limitation pattern referred by the output control portion 135B from an initial output limitation pattern to an output limitation pattern having a high output level on the basis of the battery state acquired by the battery state acquisition portion 135A. When the output limitation pattern is changed, the output limitation pattern change portion 135C rewrites the output control pattern ID associated with the battery ID.

The used battery determination portion 135D determines whether or not the battery 32 mounted on the vehicle 10 is a used battery. For example, in a used battery, information indicating that the battery is a used battery is written in the storage part 35 of the battery device 30. The used battery determination portion 135D determines whether the mounted battery 32 is a new battery or a used battery on the basis of the information read from the storage part 35 of the battery device 30.

In a case where the used battery determination portion 135D determines that the battery 32 mounted on the vehicle 10 is a used battery, the output control portion 135B may set the output limitation pattern P3 having the lowest output level and control the output of the battery 32 with reference to the set output limitation pattern P3. On the other hand, in a case where the used battery determination portion 135D determines that the battery 32 mounted on the vehicle 10 is a new battery, the output control portion 135B may set the output limitation pattern P1 having the highest output level and control the output of the battery 32 with reference to the set output limitation pattern P1. Thereby, the output of the battery 32 is not limited in a case where a new battery is attached to the vehicle 10, and the output of the battery 32 can be limited in a case where a used battery is attached to the vehicle 10.

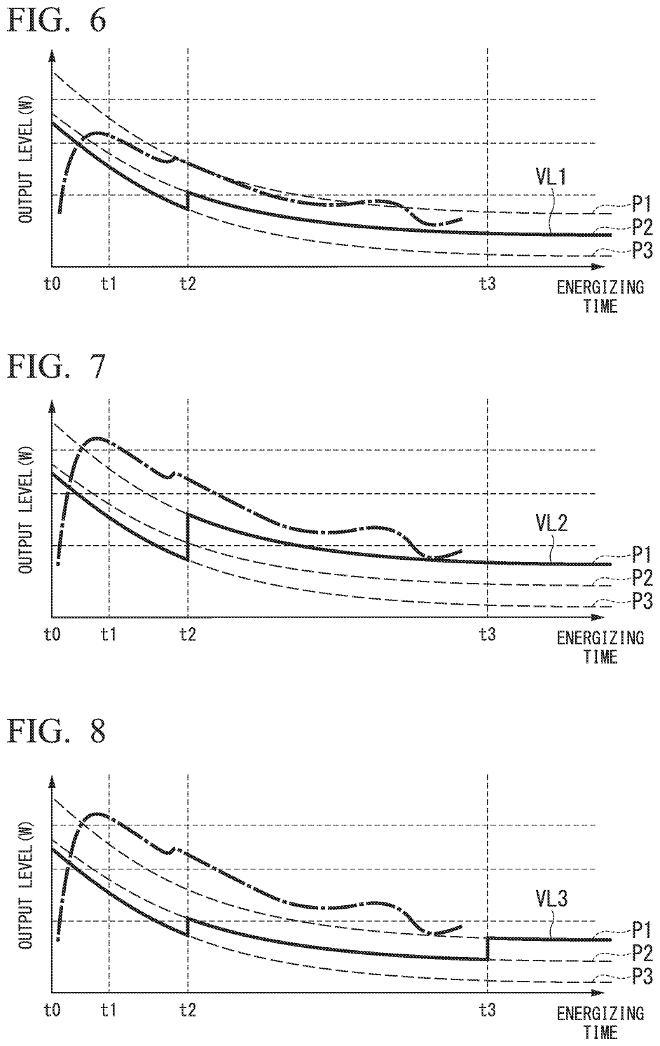

Next, an example of the output limit by the output control portion 135B is described with reference to FIGS. 6 to 8.

In a case where the output control of the battery 32 is started, the output control portion 135B sets the output limitation pattern P3 having the lowest output level and limits the output of the battery 32. Next, the battery state acquisition portion 135A acquires the battery state of the battery 32. In a case where the acquired battery state is the state level R3, the output limitation pattern change portion 135C does not change the output limitation pattern. On the other hand, in a case where the acquired battery state is the state level R2, the output limitation pattern change portion 135C changes the output limitation pattern from the output limitation pattern P3 to the output limitation pattern P2. A change example of the output limitation pattern is shown in FIG. 6.

FIG. 6 is a reference view showing an example of an output limitation (1). In the drawing, an output level VL1 shows an upper limit value of the output of the battery 32 limited by the output control portion 135B. At a time t0 when the output control is started, the output limitation pattern P3 is set, and the output limitation pattern P3 is changed to the output limitation pattern P2 at a time t2. Thereby, at a time point when the output control is started, the output level can be made low, and after the battery state is acquired, the output of the battery 32 can be controlled to an output level corresponding to the degradation degree of the battery 32.

In a case where the battery state of the battery 32 acquired by the battery state acquisition portion 135A is the state level R1, the output limitation pattern change portion 135C changes the output limitation pattern from the output limitation pattern P3 to the output limitation pattern P1. A change example of the output limitation pattern is shown in FIG. 7. FIG. 7 is a reference view showing an example of an output limitation (2). In the drawing, an output level VL2 shows an upper limit value of the output of the battery 32 limited by the output control portion 135B. At a time t0 when the output control is started, the output limitation pattern P3 is set, and the output limitation pattern P3 is changed to the output limitation pattern P1 at a time t2. Thereby, at a time point when the output control is started, the output level can be made low, and after the battery state is acquired, the output of the battery 32 can be controlled to an output level corresponding to the degradation degree of the battery 32.

In a case where the battery state acquired by the battery state acquisition portion 135A is the state level R1, the output limitation pattern change portion 135C may change the output limitation pattern in a step-by-step manner from the output limitation pattern P3 to the output limitation pattern P1. For example, the output limitation pattern change portion 135C changes the output limitation pattern in a step-by-step manner such that the output level is gradually increased on the basis of an elapsed time from the time t0 when the output control is started. A change example of the output limitation pattern is shown in FIG. 8. FIG. 8 is a reference view showing an example of an output limitation (3). In the drawing, an output level VL3 shows an upper limit value of the output of the battery 32 limited by the output control portion 135B. The output limitation pattern change portion 135C, for example, changes the output limitation pattern to the output limitation pattern P2 at a time t2 and changes the output limitation pattern to the output limitation pattern P1 at a time t3.

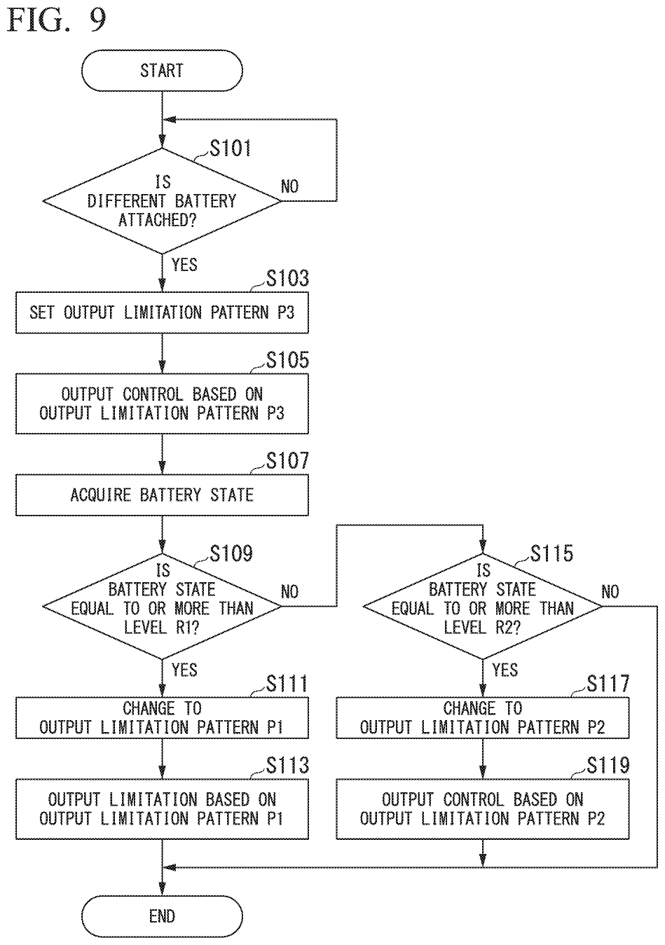

FIG. 9 is a flowchart showing an example of a process flow by the control part 130. First, the output control portion 135B refers to, for example, the battery ID stored in the storage portion 135M and determines whether or not a battery different from a battery previously mounted is mounted (Step S101). In a case where a different battery is mounted, the output control portion 135B sets the output limitation pattern P3 having the lowest output level (Step S103). The output control portion 135B controls the output of the battery 32 with reference to the set output limitation pattern P3 (Step S105).

Next, the battery state acquisition portion 135A acquires the battery state (Step S107). For example, the battery state acquisition portion 135A reads the charging information from the storage part 35 of the battery device 30, refers to the three-dimensional space model information 135Ma, and acquires the battery state of the battery 32 on the basis of the coordinate corresponding to the read charging information. The output limitation pattern change portion 135C determines whether or not the acquired battery state is equal to or more than the state level R1 (Step S109).

In Step S109, in a case where the battery state is equal to or more than the state level R1, the output limitation pattern change portion 135C changes the output limitation pattern from the output limitation pattern P3 to the output limitation pattern P1 (Step S111). The output control portion 135B controls the output of the battery 32 with reference to the output limitation pattern P1 (Step S113). In Step S111, the output limitation pattern change portion 135C may change the output limitation pattern in a step-by-step manner in accordance with the elapsed time from the time when the output control of the battery 32 is started.

On the other hand, in a case where the battery state is not equal to or more than the state level R1 in Step S109, the output limitation pattern change portion 135C determines whether or not the battery state acquired in Step S107 is equal to or more than the state level R2 (Step S115). In a case where the battery state is equal to or more than the state level R2 in Step S115, the output limitation pattern change portion 135C changes the output limitation pattern from the output limitation pattern P3 to the output limitation pattern P2 (Step S117). The output control portion 135B controls the output of the battery 32 with reference to the output limitation pattern P2 (Step S119). On the other hand, in a case where the battery state is not equal to or more than the state level R2 in Step S115, the output limitation pattern change portion 135C does not change the output limitation pattern and ends the process.

Instead of the process of Step S101, the used battery determination portion 135D may determine whether or not the battery 32 mounted on the vehicle 10 is a used battery. In a case where it is determined that the battery 32 mounted on the vehicle 10 is a used battery, the process of Step S103 and subsequent processes are performed.

[Summary of Embodiment]

As described above, the control apparatus 100 of the present embodiment includes: the battery state acquisition portion 135A that acquires a state of a battery that is mounted on the vehicle 10; a control part that performs an output control of the battery 32; and the output limitation pattern change portion that controls an output of a battery attached to the vehicle 10 with reference to one output limitation pattern set from a plurality of output limitation patterns each having a different output level and changes the output limitation pattern from an initial output limitation pattern to an output limitation pattern having a high output level based on the acquired state of the battery. Thereby, it is possible to appropriately control the output of the battery that is secondarily utilized.

### Second Embodiment

Next, a second embodiment is described. The second embodiment differs from the first embodiment in that after a battery state is acquired first, a battery state is acquired again in accordance with the battery state acquired first, and the output limitation pattern is changed. Hereinafter, the point different from the first embodiment is described, and description of similar points is omitted.

The battery state acquisition portion 135A derives a coordinate in a three-dimensional space model on the basis of a detection result of a battery parameter at a predetermined interval. The battery state acquisition portion 135A acquires the most recent battery state on the basis of the transition (change) of the battery state indicated by the coordinate.

The output limitation pattern change portion 135C changes the set output limitation pattern in a case where the battery state acquired by the battery state acquisition portion 135A changes. For example, in a case where the battery state changes from a high degradation degree of the battery 32 to a low degradation degree of the battery 32, the output limitation pattern change portion 135C changes the set output limitation pattern from an output limitation pattern having a low output level to an output limitation pattern having a high output level.

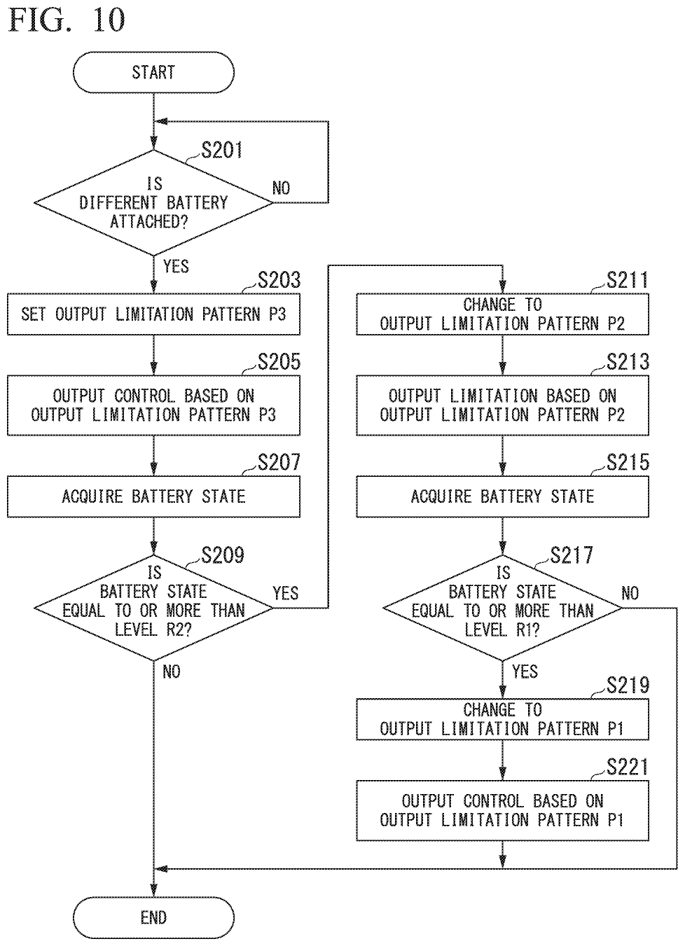

FIG. 10 is a flowchart showing an example of a process flow by the control part 130. First, the output control portion 135B refers to, for example, the battery ID stored in the storage portion 135M and determines whether or not a battery different from a battery previously mounted is mounted (Step S201). In a case where a different battery is mounted, the output control portion 135B sets the output limitation pattern P3 having the lowest output level (Step S203). The output control portion 135B controls the output of the battery 32 with reference to the set output limitation pattern P3 (Step S205).

Next, the battery state acquisition portion 135A acquires the battery state (Step S207). For example, the battery state acquisition portion 135A reads the charging information from the storage part 35 of the battery device 30, refers to the three-dimensional space model information 135Ma, and acquires the battery state of the battery 32 on the basis of the coordinate corresponding to the read charging information. The output limitation pattern change portion 135C determines whether or not the acquired battery state is equal to or more than the state level R2 (Step S209).

In a case where the battery state is not equal to or more than the state level R2 in Step S209, the output limitation pattern change portion 135C does not change the output limitation pattern and ends the process.

On the other hand, in a case where the battery state is equal to or more than the state level R2 in Step S209, the output limitation pattern change portion 135C changes the output limitation pattern from the output limitation pattern P3 to the output limitation pattern P2 (Step S211). The output control portion 135B controls the output of the battery 32 with reference to the output limitation pattern P2 (Step S213).

Next, the battery state acquisition portion 135A acquires the battery state (Step S215). For example, the battery state acquisition portion 135A derives a coordinate in a three-dimensional space model on the basis of a detection result of a battery parameter of the battery sensor 40 and acquires the battery state of the battery 32 on the basis of the transition from the coordinate derived in Step S207.

Then, the output limitation pattern change portion 135C determines whether or not the battery state acquired in Step S215 is equal to or more than the state level R1 (Step S217). In a case where the battery state is equal to or more than the state level R1 in Step S217, the output limitation pattern change portion 135C changes the output limitation pattern from the output limitation pattern P2 to the output limitation pattern P1 (Step S219). The output control portion 135B controls the output of the battery 32 with reference to the output limitation pattern P1 (Step S221).

Instead of the process of Step S201, the used battery determination portion 135D may determine whether or not the battery 32 mounted on the vehicle 10 is a used battery. In a case where it is determined that the battery 32 mounted on the vehicle 10 is a used battery, the process of Step S203 and subsequent processes are performed.

The embodiments described above can be represented as follows: a control apparatus that includes a storage device that stores a program and a hardware processor, wherein by executing the program stored in the storage device, the hardware processor acquires a state of a battery that is mounted on an electric vehicle, controls an output of a battery attached to an electric vehicle with reference to one output limitation pattern set from a plurality of output limitation patterns each having a different output level, and changes the output limitation pattern from an initial output limitation pattern to an output limitation pattern having a high output level based on the acquired state of the battery.

Although embodiments of the present invention have been described, the present invention is not limited to such embodiments, and various modifications and substitutions can be made without departing from the scope of the invention.

What is claimed is:

1. A control apparatus comprising:
an acquisition part that acquires a state of a battery that is mounted on an electric vehicle; and
a control part that performs an output control of the battery,
wherein the control part controls an output of a battery attached to an electric vehicle with reference to one output limitation pattern set from a plurality of output limitation patterns each having a different output level and changes the output limitation pattern from an initial output limitation pattern to an output limitation pattern having a high output level based on the acquired state of the battery.

2. The control apparatus according to claim 1,
wherein the control part changes the output limitation pattern such that the output level of the output limitation pattern referred by the control part is increased in a step-by-step manner based on the acquired state of the battery.

3. The control apparatus according to claim 1,
wherein the control part limits the output of the battery with reference to an output limitation pattern having the lowest output level among the plurality of output limitation patterns in a case where a battery different from the battery that has been attached to the electric vehicle is attached to the electric vehicle.

4. The control apparatus according to claim 1,
wherein the control part limits the output of the battery with reference to an output limitation pattern having the lowest output level among the plurality of output limitation patterns in a case where a used battery is attached to the electric vehicle.

5. The control apparatus according to claim 1,
wherein the control part acquires the state of the battery based on a detection value of a battery sensor attached to the battery using a capacitance of the battery, a SOC-OCV curve of the battery, and a three-dimensional space model of an internal resistance of the battery.

6. A control method, by way of a computer, including:
acquiring a state of a battery that is mounted on an electric vehicle;
controlling an output of a battery attached to an electric vehicle with reference to one output limitation pattern set from a plurality of output limitation patterns each having a different output level; and
changing the output limitation pattern from an initial output limitation pattern to an output limitation pattern having a high output level based on the acquired state of the battery.

7. A computer-readable non-transitory storage medium that includes a program causing a computer to:
acquire a state of a battery that is mounted on an electric vehicle;
control an output of a battery attached to an electric vehicle with reference to one output limitation pattern set from a plurality of output limitation patterns each having a different output level; and
change the output limitation pattern from an initial output limitation pattern to an output limitation pattern having a high output level based on the acquired state of the battery.
